(19) United States
(12) Patent Application Publication
(10) Pub. No.: US 2019/0144062 A1
(43) Pub. Date: May 16, 2019

(54) Illuminable display responsive to motions of a host vehicle

(71) Applicant: Wayne Gerard Poole, Alexandria, VA (US)

(72) Inventor: Wayne Gerard Poole, Alexandria, VA (US)

(21) Appl. No.: 16/350,375

(22) Filed: Nov. 13, 2018

Related U.S. Application Data
(60) Provisional application No. 62/707,629, filed on Nov. 13, 2017.

(51) Int. Cl. B62J 6/00; B62J 3/00; B62K 19/40

(52) U.S. Cl. CPC B62J 6/001; B62K 19/40; B62J 3/00

(57) ABSTRACT

A system including a programmable lighting display, together with sensors of motion parameters of a vehicle is disclosed. Once programmed, the system functions automatically to produce selected visual effects on the lighting display. The lighting display is visible from the exterior of the vehicle, although illuminable elements may be contained within translucent or transparent elements of the vehicle. Sensed parameters of motion may include forward acceleration and/or velocity, rearward acceleration and/or velocity, inclination, vertical acceleration and/or velocity, and loss of and re-establishing of contact with the ground. The lighting display may comprise multi-colored LEDs. Visual effects may include color or hue selection, intermittent illumination or flashing, sequencing of lights to create the impression of waves, and other visual effects.

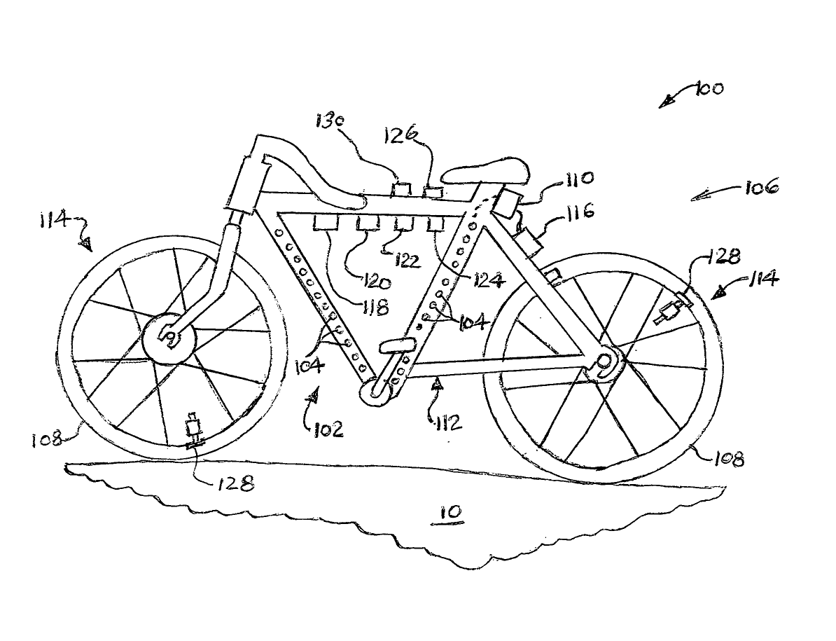

### FIELD OF THE DISCLOSURE

The present disclosure relates to dynamic lighting displays, and more particularly, to a lighting display carried aboard a vehicle, wherein the lighting display is automatically responsive to motions of the vehicle.

### BACKGROUND

Lighting displays aboard vehicles are known, and have been used for amusement, advertising, advising of emergency vehicle status, and for other purposes. However, their use to annunciate motions of the vehicle is very limited. There exists the possibility to expand the use of lighting displays to annunciate and respond to motion characteristics of a moving vehicle.

### SUMMARY

The disclosed concepts address the above stated situation by providing a system including a programmable lighting display, together with sensors of motion parameters of a vehicle. Once programmed, the system functions automatically to produce selected visual effects on the lighting display. The lighting display is visible from the exterior of the vehicle, although illuminable elements may be contained within translucent or transparent elements of the vehicle. frame, and the lighting display may comprise a plurality of LEDs carried inside the at least partially translucent body or frame. The example of U.S. Pat. No. 9,944,339, illustrates translucent or transparent frame 112. Light emitted by the LEDs is visible from the outside of the body or frame.

By way of summary and not by way of limitation, lighting display 102 may comprise a strip of light emitting diodes (LEDs) carried within transparent or transparent tubes of frame 112. Microprocessor 110 may include a memory and computer instructions loaded into the memory in a non-transitory, computer-readable medium that when executed are configured to instruct microprocessor 110 to selectively control electric power to at least some of the illuminated elements 104. A battery 116 is connected to microprocessor 110 and to at least some of the illuminated elements 104. Of course, lighting display 102 may be of a type other than LEDs, or may be partially based on LEDs and partially based on another type of illuminatable device (not shown).

Visual effects achievable when providing inputs to lighting display 102 may include color change, generating a visual impression of pixels traveling along lighting display 102 by selectively illuminating and extinguishing some of the pixels, changing speed or direction or both of apparently traveling pixels, flashing of the pixels, changing flashing frequencies, changing brightness of individual pixels, and suppressing any of these changes. Visual effects may include any of the above effects in any feasible combination.

Ground 10 will be understood to include any natural or artificial surface capable of supporting vehicle 106 and its occupants or riders, such as paved surfaces, boardwalks, sidewalks, tracks, rails and others forming natural ground and rock formations, or ultimately supported on ground or rock formations.

Ground contact surface 108 may comprise tire surfaces of wheels 114. Where vehicle 106 is a boat (not shown), water (not shown) takes the place of ground 10, and hull surfaces take the place of tire surfaces providing ground contact surface 108. In other implementations, vehicle 106 could be a skateboard, a scooter, a pair of roller skates, skis, ice skates, a sled, a surf board, a raft, a kayak, a canoe, a punt, a unicycle, a bicycle, a tricycle, snow boards, single axle two wheeled vehicles, wagons, carts, gliders, and other personal craft, whether powered by animals, by an occupant, or motorized.

As employed herein reference to an article as being aboard or on vehicle 106 or frame 112 does not necessarily imply direct connection between the article and vehicle 106 or frame 112, as an intervening member may be present. Being on vehicle 106 or frame 112 signifies that the article is ultimately coupled to and supported by vehicle 106 or frame 112.

Illuminated elements 104 of lighting display 102 may comprise three-part LED assemblies each including one red LED, one green LED, and one blue LED. Each three-part LED assembly may be individually addressable because each part of the three is served by a dedicated power conductor contained within and integral to a strip (not separately shown) of LEDs. Selective powering of each of the three results in the three-part LED assembly being multi-color, and independently controllable relative to for example adjacent three-part LED assemblies. Such LEDs may be controlled such that each emits light selectively of different colors. This minimizes the number of LEDs that must be provided. LEDs throughout the entire lighting system may be identical in type, size, luminosity, etc.

The plurality of motion parameter sensors may include at least two of a forward accelerometer 118 (i.e., a gyroscope or other accelerometer responsive to changes of velocity in a forward direction), a rearward accelerometer 120, a forward velocity sensor 122, a rearward velocity sensor 124, and a vertical acclerometer 126. The motion parameter sensors may include an inclination sensor 130. Where feasible, two or more motion parameter sensors may be combined into one device. The motion parameter sensors are in communication with microprocessor 110, the latter controlling lighting display 102 in response to inputs from the motion parameter sensors.

Vertical accelerometer 126 may comprise a mass on a pivoting arm for example, or alternatively, may further comprise a sensor 128 capable of sensing establishment and loss of contact with ground 10. For example, sensors 128 may comprise pressure sensors capable of discerning different pressures acting on tire surfaces of wheels 114. Sensors 128 may comprise piezoelectric elements for example. All sensors 118, 120, 122, 124, 126, 128 may include wireless communications devices or hard wired connections to communicate with microprocessor 110.

Loss of contact with the ground may be intentional on the part of a rider such as a bicycle rider. For example, some riders like to incorporate maneuvers such as somersaults and twirls into the ride, particularly when participating in displays of skill. To modify the display would emphasize or otherwise signal a feat to onlookers. Changing the display could also be employed to measure a time interval during which a bike is in the air.

The invention may be thought of as a method of controlling lighting display 102 having illuminated elements 104 aboard vehicle 106 at least periodically in contact with ground 10. The method may comprise steps of sensing a first motion parameter of vehicle 106 and responsively effecting a first visual effect realized on the lighting display; and sensing a second motion parameter of vehicle 106 and responsively effecting a second visual effect on lighting display 102. The motion parameters may include forward or rearward acceleration, forward, constant, or rearward acceleration, vertical acceleration, inclination of vehicle 106, and establishing and losing contact with ground 10.

Unless otherwise indicated, the terms “first”, “second”, etc., are used herein merely as labels, and are not intended to impose ordinal, positional, or hierarchical requirements on the times to which these terms refer. Moreover, reference to, e.g., a “second” item does not either require or preclude the existence of, e.g., a “first” or lower-numbered item, and/or, e.g., a “third” or higher-numbered item.

In the method, the step of sensing a first motion parameter of vehicle 106 and responsively effecting a first visual effect realized on the lighting display may comprise at least one of sensing forward velocity, sensing rearward velocity, sensing forward acceleration, sensing rearward velocity, sensing upward acceleration, sensing downward acceleration, sensing right inclination, sensing left inclination, sensing loss of contact with the ground, and sensing renewal of contact with the ground. Where vehicle 106 includes a plurality of wheels 114 at least periodically in contact with ground 10, the step of sensing a first motion parameter of vehicle 106 and responsively effecting a first visual effect realized on lighting display 102 may comprise sensing loss of contact with ground 10 by one or both of wheels 114 and continued or re-established contact with ground 10.

Loss of contact with the ground may be inferred by one or more accelerometers sensing a three hundred sixty degree rotation of vehicle 106 about at least one of an axis perpendicular to a vertical longitudinal or transverse plane (or both) occupied by an arbitrary point on vehicle 106. Another way of determining loss of contact with the ground is sensing of a sudden sharp deceleration of vehicle 106 in a vertical direction shortly after having experienced a rotation in a vertical longitudinal or transverse plane (or both) when vehicle 106 again contacts ground 10 after having left ground 10. In a competition, it may be desirable to use lighting display 102 to annunciate a somersault wherein rotation occurs in only the longitudinal plane or only in the transverse plane, as a somersault in only one plane without leaning in the other plane may be regarded as a more difficult feat. In a similar vein, ability to achieve and annunciate higher velocities and greater lean (deviation from an upright orientation to the ground) may be desirable. In these cases, ability of system 100 to signal an achieved feat may lead to greater appreciation by observers, and where competitive scoring is used, an objective judgment of a difficult feat, this leading to a particular participant being deemed a winner of the competition.

Loss of contact with the ground may be intentional on the part of the rider of vehicle 106. Illustratively, in extreme bicycle sports, bicycles are ridden on courses including ramps configured such that a cyclist leaves contact with the course and briefly free falls, as would be done to enable the cyclist to perform a somersault. The ramp is comparable to a take-off of a ski jump course.

In the method, the step of sensing the second motion parameter of vehicle 106 and responsively effecting the second visual effect on lighting display 102 may further comprise changing at least one of the illuminated elements 104 of the first visual effect

In the method, the step of effecting a first visual effect and the step of effecting a second visual effect may include at least some of establishing at least a first hue, varying intensity of a hue, intermittently illuminating and extinguishing individual illuminated elements 104 of lighting display 102, illuminating a first hue in at least one first illuminated element 104 and a second hue in at least one second illuminated element 104, and selectively controlling time durations during which individual illuminable elements 104 are subjected to illumination.

The method may comprise determining performance of a somersault. As employed herein, “determining” may signify direct sensing, such as an accelerometer directly sensing acceleration, or may signify a calculation, a comparison of several sensings, etc., so that a condition may be inferred rather than directly sensed. In an example, should a velocity motion sensor sense lack of velocity, with another motion sensor simultaneously sensing lean at an angle deviating from the upright by more than sixty degrees, an inference may be made that where vehicle 106 is a bicycle, the bicycle has fallen to the ground. A gyroscope (not separately shown) may sense rotation of vehicle 106 for three hundred sixty degrees, with second gyroscope sensing lack of lean or inclination in one vertical plane. In this latter example, and where no lean in a transverse direction is sensed, performance of a somersault may be determined by inference.

A plurality of motion parameter sensors may be employed to enable determining, in addition to performing a somersault, at least one parameter of bicycle motion including including leaning in a fore and aft direction, transverse leaning, acceleration, deceleration, wheel stand, falling to the ground.

The method may further comprise associating one particular motion parameter with one particular visual effect when operating lighting display 102, such that subsequent repeated motions are signaled by respective consistent visual effects. As employed herein, associating a motion with a visual effect signifies that any selected motion results in a unique visual effect reserved for use only with that selected motion. Of course, it is possible to program or to change the lighting scheme such that the same motion produces a different visual effect in subsequent occurrences.

In a hypothetical example of the method, a bicycle rider programs microprocessor 110 such that each motion parameter produces a visual effect on lighting display 102 as follows. As vehicle 106 accelerates from a stop, lighting display 102 may active some illuminated elements 104 to produce an effect creating an impression of purple waves moving slowly backwardly, and optionally to move backwardly faster with increased perceived velocity. Selective lighting of individual elements of an array of lighting elements to produced perceived motion is well known and need not be further detailed herein. At a predetermined velocity threshhold, the purple waves become red waves. When moving forwardly, the red waves become yellow. Upon encountering a left turn, vehicle 106 leans to the left, and the previously red waves become green. When vehicle 106 encounters a right turn, vehicle 106 leans to the right, and either green or red waves become blue waves. When vehicle 106 ascends a hill or ramp, more illuminated elements 104 become activated, thereby modifying or terminating the wave effect. If vehicle 106 becomes airborne, perhaps as a result of an extreme maneuver, illuminated elements 104 become a brilliant white and begin to flash simultaneously. Upon contacting the ground after the extreme maneuver, illuminated elements 104 become yellow, red, and green in rapid succession, then revert to a predetermined color signifying forward motion.

It should be understood that the various examples of the apparatus(es) disclosed herein may include any of the components, features, and functionalities of any of the other examples of the apparatus(es) disclosed herein in any feasible combination, and all of such possibilities are intended to be within the spirit and scope of the present disclosure. Many modifications of examples set forth herein will come to mind to one skilled in the art to which the present disclosure pertains having the benefit of the teachings presented in the included descriptions and associated drawing.

Therefore, it is to be understood that the present disclosure is not to be limited to the specific examples presented and that modifications and other examples are intended to be included within the scope of the appended claims. Moreover, although the foregoing description and the associated drawings describe examples of the present disclosure in the context of certain illustrative combinations of elements and/or functions, it should be appreciated that different combinations of elements and/or functions may be provided by alternative implementations without departing from the scope of the appended claims.

I claim:

1. A system for controlling a lighting display having illuminated elements aboard a vehicle at least periodically in contact with the ground, the system comprising:
a vehicle having a ground contact surface for supporting the vehicle on the ground;
a lighting display aboard the vehicle, the lighting display including a plurality of illuminable elements visible from an exterior of the vehicle;
a microprocessor connected to the lighting display and capable of controlling individual ones of the illuminable elements of the lighting display, the microprocessor including a non-transitory medium storing instructions executable by the lighting display to illuminate the illuminable elements to produce different visual effects responsive to signals indicative of individual motions of the vehicle; and
a plurality of motion parameter sensors on the vehicle and in data transfer relation to the microprocessor to provide signals to the microprocessor, wherein the signals are indicative of different individual motions of the vehicle.

2. The system of claim 1, wherein
the vehicle comprises an at least partially translucent body or frame, and
the lighting display comprises a plurality of LEDs carried inside the at least partially translucent body or frame.

3. The system of claim 1, wherein the motion parameter sensors include at least two of a forward accelerometer, a rearward accelerometer, a forward velocity sensor, a rearward velocity sensor, and a vertical accelerometer.

4. The system of claim 1, wherein the ground contact surface of the vehicle comprises at least one wheel.

5. The system of claim 3, further comprising a sensor capable of determining establishment and loss of contact with the ground.

6. The system of claim 3, further comprising a sensor capable of determining performance of a somersault.

7. The system of claim 6, wherein the motion parameter sensors can sense at least one parameter of bicycle motion including leaning in a fore and aft direction, transverse leaning, acceleration, deceleration, wheel stand, falling to the ground.

8. The system of claim 1, wherein the vehicle is a bicycle.

9. A method of controlling a lighting display having illuminated elements aboard a vehicle at least periodically in contact with the ground, the method comprising the steps of:
sensing a first motion parameter of the vehicle and responsively effecting a first visual effect realized on the lighting display; and
sensing a second motion parameter of the vehicle and responsively effecting a second visual effect on the lighting display.

10. The method of claim 9, wherein the step of sensing a first motion parameter of the vehicle and responsively effecting a first visual effect realized on the lighting display comprises at least one of sensing forward velocity, sensing rearward velocity, sensing forward acceleration, sensing rearward velocity, sensing upward acceleration, sensing downward acceleration, sensing right inclination, sensing left inclination, sensing loss of contact with the ground, and sensing renewal of contact with the ground.

11. The method of claim 9, wherein the vehicle includes a plurality of wheels at least periodically in contact with the ground, and the step of sensing a first motion parameter of the vehicle and responsively effecting a first visual effect realized on the lighting display comprises sensing loss of contact with the ground by one of the wheels and continued contact with the ground.

12. The method of claim 9, wherein the step of sensing the second motion parameter of the vehicle and responsively effecting the second visual effect on the lighting display further comprises changing at least one of the illuminated elements of the first visual effect.

13. The method of claim 9, wherein the step of effecting a first visual effect and the step of effecting a second visual effect include at least some of establishing at least a first hue, varying intensity of a hue, intermittently illuminating and extinguishing individual illuminated elements of the lighting display, illuminating a first hue in at least one first illuminated element and a second hue in at least one second illuminated element, and selectively controlling time durations during which individual illuminable elements are subjected to illumination.

14. The method of claim 9, further comprising associating one particular motion parameter with one particular visual effect when operating the lighting display.

15. The method of claim 9, further comprising determining performance of a somersault.

16. The method of claim 15, further comprising determining, in addition to performing a somersault, at least one parameter of bicycle motion including including leaning in a fore and aft direction, transverse leaning, acceleration, deceleration, wheel stand, falling to the ground.
